(19) United States
(12) Patent Application Publication
(10) Pub. No.: US 2019/0243727 A1
(43) Pub. Date: Aug. 8, 2019

(54) EFFICIENTLY RECOVERING LOG-STRUCTURED FILESYSTEMS FROM CRASHES

(71) Applicant: EMC IP Holding Company LLC, Hopkinton, MA (US)

(72) Inventors: Jayasekhar Konduru, Sunnyvale, CA (US); Ashwani Mujoo, San Jose, CA (US)

(21) Appl. No.: 15/887,736

(22) Filed: Feb. 2, 2018

(51) Int. Cl. G06F 11/14; G06F 17/30

(52) U.S. Cl. CPC G06F 11/1469; G06F 2201/84; G06F 17/30174

(57) ABSTRACT

Systems and methods can present recovery of a log-structured file system. Embodiments can provide defining a recovery region of the log-structured file system. A set of metadata blocks for the recovery region can be selected. A first set of logical blocks referred to by the set of metadata blocks can also be selected. The logical blocks in the first set of logical blocks can be accepted into the log-structured file system. A second set of logical blocks for the recovery region such that each of the logical blocks in the second set is in an intermediate state can be selected. The blocks in the second set that pass a validation test can be accepted into the log-structured file system. The logical storage and physical storage of the log-structured file system can be synchronized.

### FIELD

This invention relates generally to data storage and deduplication, and more particularly to recovery of lost or corrupted log-structured filesystems.

### BACKGROUND

In a log-structured filesystem, data is written sequentially in a temporal order to a circular buffer called a log. The physical storage for such a filesystem could be coming from one or more block based devices and/or object based storage. Log-structured filesystem have metadata and generally optimize the number of metadata syncs between the log and physical storage to reduce the performance overhead. This can increase the amount of work required while recovering from crashes as the metadata lag can be higher. This can affect the filesystem bring-up times and other performance factors.

There is a need, therefore, for an improved method, article of manufacture, and apparatus for recovery of log-structured filesystems from crashes.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a diagram illustrating log storage layout in a log structured filesystem in accordance with some embodiments of the present disclosure.

FIG. 2 is a diagram illustrating logical layout of a log structured file system in accordance with some embodiments of the present disclosure.

FIG. 3 is a diagram illustrating storage layout in a log structured filesystem in accordance with some embodiments of the present disclosure.

FIG. 4 is a flowchart of a method for recovering a log-structured file system in accordance with some embodiments of the present disclosure.

FIG. 5 is a block diagram of an example computer system usable with system and methods according to various embodiments.

### BRIEF SUMMARY

Embodiments can improve data storage processes in a log-structured file system, by systems and methods to recover the filesystem data and metadata after a crash. In such a system, the crash recovery time and the I/O needed can be improved in a log-structured filesystem. The methods leverage hints supplied by trusted/coordinated filesystem data and methods to recover the filesystem data and metadata are presented.

Other embodiments are directed to systems, portable consumer devices, and computer readable media associated with methods described herein.

A better understanding of the nature and advantages of embodiments may be gained with reference to this detailed description and the accompanying drawings.

### DETAILED DESCRIPTION

A detailed description of one or more embodiments of the invention is provided below along with accompanying figures that illustrate the principles of the invention. While the invention is described in conjunction with such embodiment(s), it should be understood that the invention is not limited to any one embodiment. On the contrary, the scope of the invention is limited only by the claims and the invention encompasses numerous alternatives, modifications, and equivalents. For the purpose of example, numerous specific details are set forth in the following description in order to provide a thorough understanding of the present invention. These details are provided for the purpose of example, and the present invention may be practiced according to the claims without some or all of these specific details. For the purpose of clarity, technical material that is known in the technical fields related to the invention has not been described in detail so that the present invention is not unnecessarily obscured.

It should be appreciated that the present invention can be implemented in numerous ways, including as a process, an apparatus, a system, a device, a method, or a computer readable medium such as a computer readable storage medium or a computer network wherein computer program instructions are sent over optical or electronic communication links. Applications may take the form of software executing on a general purpose computer or be hardwired or hard coded in hardware. In this specification, these implementations, or any other form that the invention may take, may be referred to as techniques. In general, the order of the steps of disclosed processes may be altered within the scope of the invention.

In certain computer storage systems, the filesystem can use a cloud-based object store as target storage. In these systems, a log structured filesystem such a Data Domain's log-structured file system (DDFS) is built on the cloud object storage. Similarly, a log-structured file-system such as DDFS may use non-cloud-based object storage for target storage. An embodiment of the invention will be described with reference to a DDFS, but it should be understood that the principles of the invention are not limited to this configuration. The solutions to these problems provided by some embodiments may be applied to multiple different types of log-structured file systems, and certain examples in this application use a DDFS in particular as an example for the purposes of illustration and description. It is not intended to be exhaustive or to limit embodiments to the precise form described, an embodiment can be applied to other systems.

A log-structured filesystem is a file system in which data and metadata are written sequentially to a circular buffer, called a log. When there is new data to write, it is appended to the end of the log. Indexing stored data is accomplished using filesystem metadata. The filesystem can keep track of filesystem metadata such as the head and tail of the log: log-head and log-tail, respectively. In a log-structured filesystem, the disk can be divided up into large segments, where each segment can contain a number of data blocks and associated block metadata.

Log-structured filesystems can span across block and object storage with cloud-based target storage. In DDFS, the log-structured filesystem may span across block and object storage. The block storage can be used to host the latency critical data blocks which can be required to be stored in the local block storage for efficient operation of the filesystem. Such blocks in the log can be mirrored into the object storage into a logically separate address space.

Log-structured filesystems can generally optimize the number of metadata syncs between physical local block and target object storage to reduce the performance overhead. This may increase the amount of work required to properly recover from crashes as the metadata lag can be higher. Often, the recovery process can involve processing and validating the new data blocks that were written to the log since the last metadata sync and accordingly rebuilding the new metadata. This rebuilding can affect the filesystem boot or load times. Additionally, there may be additional I/O costs incurred between target storage and the log, including for example data transfer payments to and from an underlying storage provider (e.g. public cloud provider) might charge.

The methods discussed herein can significantly improve crash recovery by reducing the time and the amount of I/O needed for crash recovery in a log structured filesystem. These methods can leverage the hints supplied by the trusted/coordinated log structured filesystem. In addition to the situation where physical storage is in cloud-based storage, the systems and methods discussed can be applicable when physical storage comprises a local filesystem data and metadata where recovery from a crash is needed to resume normal operation.

Between two synchronizations of the log-structured filesystem, data may be out of sync in various parts of the system. The states of the blocks of data may not have been written to disk or cloud in target storage. Rather, the correct state of the log-structured file-system may exist only in local block storage. Thus, the states of log-structured file system in local storage and target storage, and the state on disk may be inconsistent. When a crash occurs unexpectedly, it is very likely that a synchronization had not occurred just prior, and thus the system is out of sync.

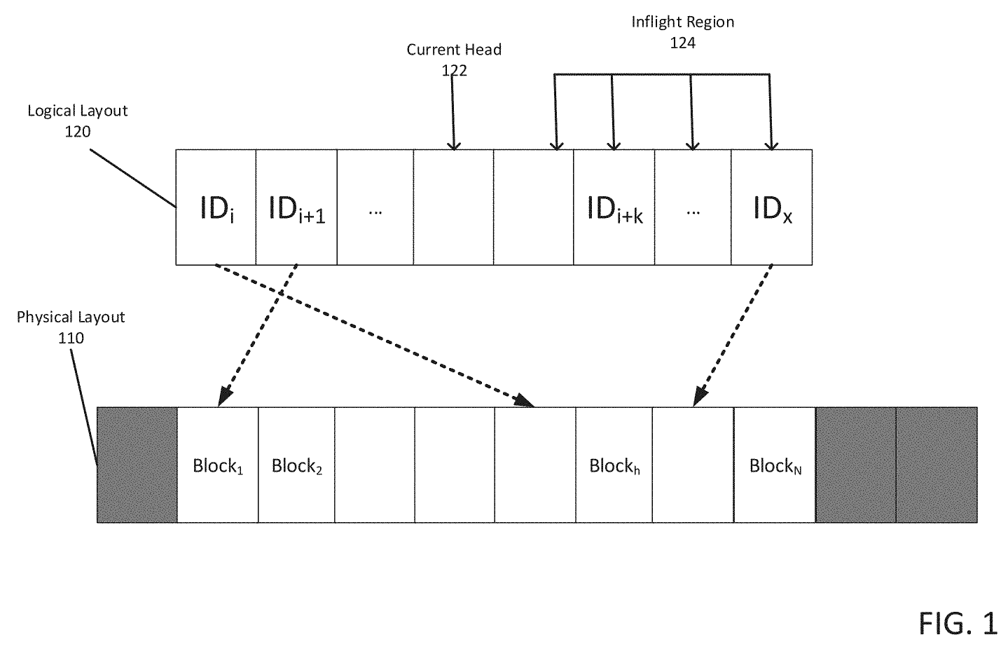

FIG. 1 depicts a log storage layout in a log structured filesystem in accordance with some embodiments of the present disclosure. In a log-based filesystem, data is written into a log, which can map to physical storage.

Element 120 represent a sample logical layout in a log-structured file system, and element 110 a sample physical layout. Sequential logical blocks IDᵢ and IDᵢ₊₁ map to physical blocks Blockₕ and Block₁ respectively. Logical layout 120 also contains the current log head 122, and a section of in-flight data in in-flight region 124. Physical layout 110 is shown in terms of blocks of data. Physical storage may consist of a variety of storage schemes including, for example a cloud-based object store or non-cloud based physical storage.

Note that and the filesystem metadata can be written into well-known locations (similar to a superblock in many other filesystems). The filesystem metadata could be large and may require more than one atomic write operation. Since the filesystem metadata updates can be in-place and can require more than one atomic write operation, it could lead to corruptions due to crashes. In order to deal with such scenarios, the log structured filesystem can have techniques to write multiple copies of metadata in a ping-pong or similar fashion.

In DDFS, the underlying log-structured file system (LSFS) can maintain the log tail, log head, a number of blocks and the mapping between logical ID to physical block (apart from other things) in its filesystem metadata. Each physical block can also store at least several pieces of block metadata. For example amongst other things, the block metadata may store an associated logical ID, it can store the block's logical type, and it may also store the block's storage state.

Metadata write costs can be amortized by batching logical ID assignment and log-head updates. That is, to decrease write costs, metadata in physical storage may not be updated constantly, instead the logical ID assignment and the log-head updates may be batched. When the number of outstanding logical IDs reaches a threshold, a fresh batch of logical IDs are assigned and the metadata is synced along with the current log-head and log-tail. Batch sizes can be any size, but often can be in the hundred, thousands or tens of thousands.

Each physical block in a log-structured file system can have an associated state in its metadata indicating a state of storage for the block. Such states can include unassigned (free/F state), where the block is not being used; assigned (AllocAssigned/AA—intermediate state) where the filesystem has indicated that it wants to eventually write to the block and thus the block is reserved; and write completed/ack'd (Alloc/A state) where data has been written to the block. This state can be stored in the block's metadata, and each block can start in a free state. When a new batch of logical IDs are assigned, each block in the batch can be moved to an intermediate state, indicating readiness and availability to write to a block.

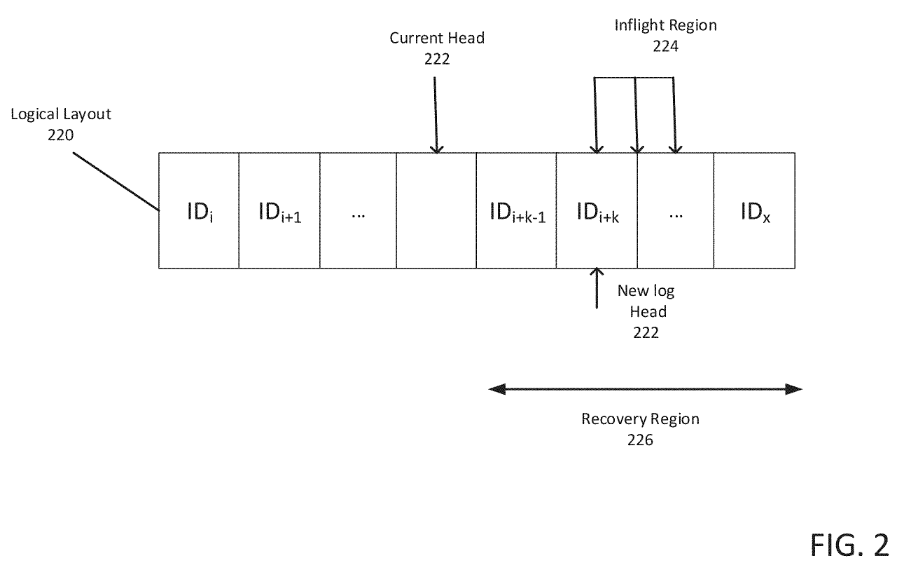

FIG. 2 is a diagram illustrating logical layout of a log structured file system in accordance with some embodiments of the present disclosure. FIG. 2 depicts the logical layout and several updates needed after a crash. In a logical layout, logical IDs such as IDᵢ and IDᵢ₊₁ can be monotonically increasing. Element 222 shows a current log-head with blocks IDᵢ₊ₖ₊₁ through IDₓ comprising a recovery region.

Recovery region 226 can comprise blocks that are ready to write to, or have not been already written to. Recovery region 226 can comprise all logical blocks from the current log head to the end of the current batch of assigned logical blocks. Recovery region 226 can be analyzed by the systems and methods described herein, to determine which blocks have already been written to and those that have not been written to, were written to, but their metadata blocks have not been written yet, or are otherwise invalid, and syncing the metadata between the local logical and physical storage.

Inflight region 224 can be determined after the time of a crash. It may comprise blocks in the recovery region that are invalid blocks. The inflight region can comprise a number of contiguous invalid blocks. Sanity checks including parity-bit checks can be performed on blocks in the inflight region. The logical block just before inflight region 224 can be set as the new log head. This is new log head 222.

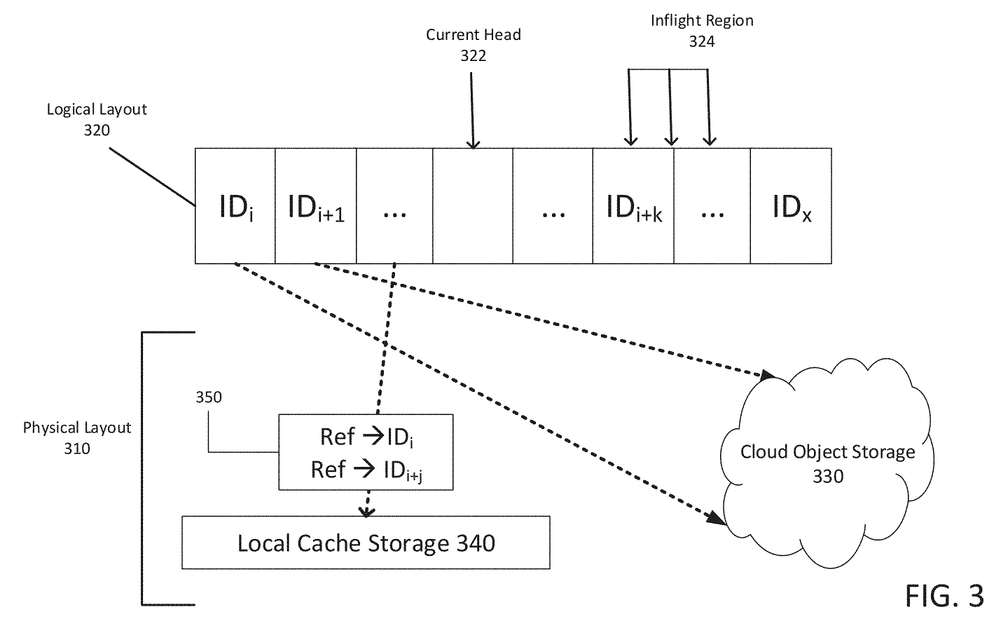

FIG. 3 illustrates a storage layout in a log structured filesystem in accordance with some embodiments of the present disclosure. FIG. 3 comprises the physical layout comprising local cache storage and target cloud object storage. Note that the target storage can exist locally or in the cloud.

Logical layout 320 represents a sample logical layout in a log-structured file system. Sequential logical blocks with IDs: IDᵢ and IDᵢ₊₁ map to physical blocks in target cloud object storage 330. Logical layout 320 also contains the current log head 322, and a section of in-flight data in inflight region 324.

Physical layout 310 is shown in terms of local storage which can include local cache storage 340, and cloud object storage 330. Physical storage may comprise a variety of storage schemes including, for example a cloud-based object store as target storage and/or non-cloud based physical storage as a target.

Local cache storage 340 can contain special blocks, such as block 350. Block 350 is a metadata block which can contain references to logical blocks that have been acknowledged; the referenced blocks have a state of A. Block 350 can have a special block type, which can help it to be identified. Local storage can use metadata blocks to track which logical blocks have been written to. However, this data may not be synced to target storage such as cloud object storage 330, which needs to be fixed to recover from a crash. The metadata blocks contain hints as to how to find which blocks have already been written to in local storage and help recover data in the blocks in the event of a crash. Local storage can also contain other special blocks such as a metadata index block, which contains a database of references to the logical IDs.

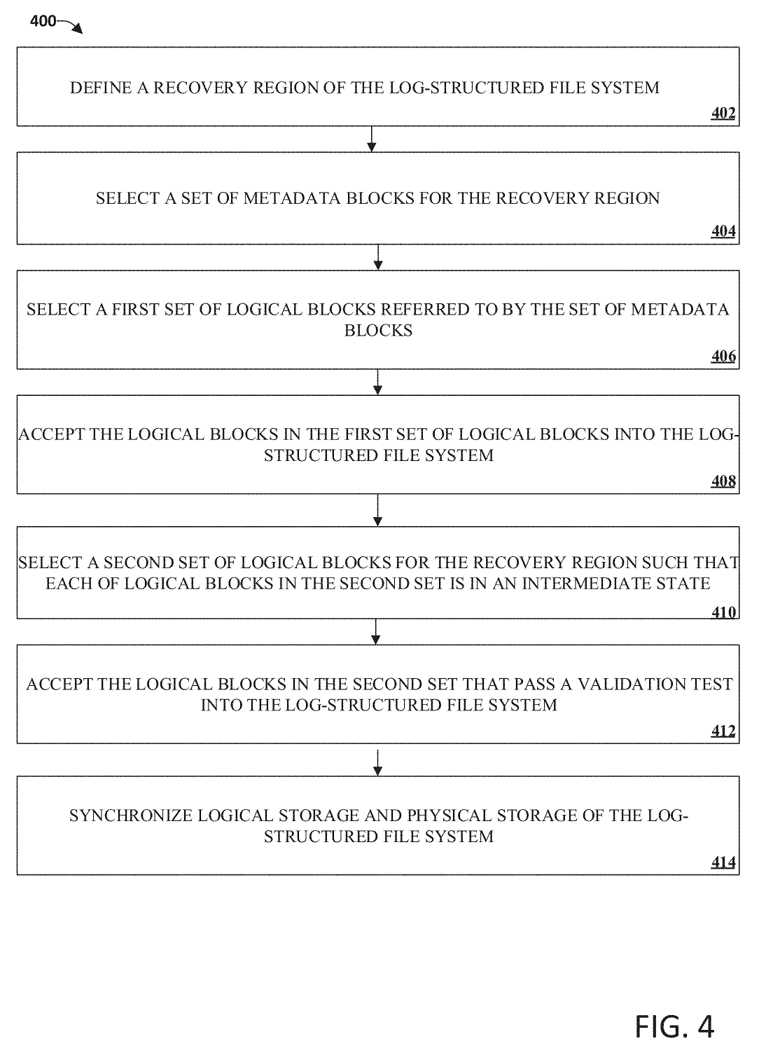

FIG. 4 is a flowchart of a method 400 for recovering a log-structured file system in accordance with some embodiments of the present disclosure. At block 402, a recovery region of the log-structured file system is defined. Starting from the current log-head, the recovery region is defined. The size of the recovery region is less than or equal to the pre-alloc batch size, going from the log head to ID_{X}, which is the last logical ID in the batch. This can mean picking all the logical blocks that are in intermediate allocation state, which can be called the AA state.

At block 404, a set of metadata blocks for the recovery region are selected. The metadata blocks can host the references to the logical blocks. Selecting the metadata blocks can be accomplished by using the filesystem hints. Using the index, the logical type of the metadata blocks can be determined. All blocks with that type can be selected using a map or other search structure. From that set, only those metadata blocks for the recovery region can be selected.

At block 406, a first set of logical blocks referred to by the set of metadata blocks can be selected. The metadata blocks in the local storage can be parsed and a set whose logical IDs falling in the recovery region can be parsed and their associated logical blocks read. The number of such blocks may be significantly smaller and may be identified using the logical type. The cost of reading a local block may be insignificant compared to reading from cloud object storage, providing a more efficient recovery.

At block 408, the set of logical blocks in the first set of logical blocks can be accepted into the log-structured file system. Each logical block that these metadata blocks refer to that is in the recovery region should have been already written successfully. Thus, no other special recovery/validation is needed for such logical blocks, and these blocks can be directly accepted in the log. This process in DDFS involves moving the state of these blocks from AA to A (AllocAssigned to Alloc).

At block 410, a second set of logical blocks for the recovery region is selected, such that each of these logical blocks in the second set is an intermediate (AA) state. Each logical block in the recovery region can be processed again. This time, the process will likely encounter less AA blocks. The process may look for blocks that were not written (or) that were written but their metadata blocks are not written yet.

Each of the blocks in the second set can then be run through a validation process to find additional blocks that should have an A state. At block 412 each block in the second set of logical blocks is read and potentially validated. Each logical block in the second set that passes a validation test is accepted into the log-structured file system. This read and validation can find blocks that were not written, or that were written but their metadata blocks are not written yet.

The process may then also determine an inflight region at the time of crash, by processing the remaining AA blocks until there is a ‘concurrent write window (an inflight region) comprising a number of contiguous invalid blocks. The previous ‘concurrent write window’ is the inflight region at the time of crash. Sanity checks may be performed to ensure that there is no AA block or invalid block in the whole recovery region past this inflight region. The logical block just before the inflight region may be declared as the new log-head. Sanity checks can include at least checking parity bits, particular signatures at offsets in a block, and validating the size of block is as expected.

At block 414, the logical storage and physical storage of the log-structured file system can be synchronized. Relevant portions of blocks in logical storage and target storage can be synchronized. The filesystem recovery can be completed by syncing the new log-head as well as the block state metadata.

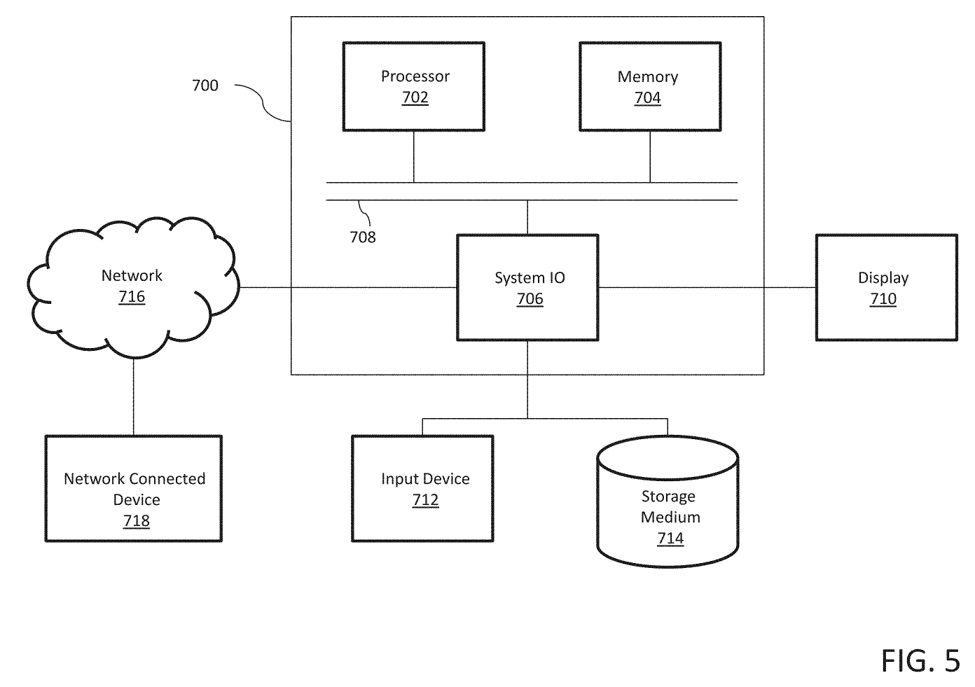

FIG. 5 depicts a computer system which may be used to implement different embodiments discussed herein. General purpose computer 500 may include processor 502, memory 504, and system IO controller 506, all of which may be in communication over system bus 508. In an embodiment, processor 502 may be a central processing unit (“CPU”) or accelerated processing unit (“APU”). Some embodiments may comprise multiple processors, or a processor with multiple cores. Processor 502 and memory 504 may together execute a computer process, such as the processes described herein.

System IO controller 506 may be in communication with display 510, input device 512, non-transitory computer readable storage medium 514, and/or network 516. Display 510 may be any computer display, such as a monitor, a smart phone screen, or wearable electronics and/or it may be an input device such as a touch screen. Input device 512 may be a keyboard, mouse, track-pad, camera, microphone, or the like, and storage medium 514 may comprise a hard drive, flash drive, solid state drive, magnetic tape, magnetic disk, optical disk, or any other computer readable and/or writable medium.

Network 516 may be any computer network, such as a local area network (“LAN”), wide area network (“WAN”) such as the internet, a corporate intranet, a metropolitan area network (“MAN”), a storage area network (“SAN”), a cellular network, a personal area network (PAN), or any combination thereof. Further, network 516 may be either wired or wireless or any combination thereof, and may provide input to or receive output from IO controller 506. In an embodiment, network 516 may be in communication with one or more network connected devices 518, such as another general purpose computer, smart phone, PDA, storage device, tablet computer, or any other device capable of connecting to a network.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor.

All references cited herein are intended to be incorporated by reference. Although the present invention has been described above in terms of specific embodiments, it is anticipated that alterations and modifications to this invention will no doubt become apparent to those skilled in the art and may be practiced within the scope and equivalents of the appended claims. More than one computer may be used, such as by using multiple computers in a parallel or load-sharing arrangement or distributing tasks across multiple computers such that, as a whole, they perform the functions of the components identified herein; i.e. they take the place of a single computer. Various functions described above may be performed by a single process or groups of processes, on a single computer or distributed over several computers. Processes may invoke other processes to handle certain tasks. A single storage device may be used, or several may be used to take the place of a single storage device. The disclosed embodiments are illustrative and not restrictive, and the invention is not to be limited to the details given herein. There are many alternative ways of implementing the invention. It is therefore intended that the disclosure and following claims be interpreted as covering all such alterations and modifications as fall within the true spirit and scope of the invention.

What is claimed is:

1. A computer-implemented method for recovering a log-structured file system, the method comprising:
defining a recovery region of the log-structured file system;
selecting a set of metadata blocks for the recovery region;
selecting a first set of logical blocks referred to by the set of metadata blocks;
accepting the logical blocks in the first set of logical blocks into the log-structured file system;
selecting the second set of logical blocks for the recovery region such that each of the logical blocks in the second set is in an intermediate state;
accepting into the log-structured file system logical blocks in the second set that pass a validation test; and
synchronizing logical storage and physical storage of the log-structured file system.

2. The method of claim 1, further comprising determining an inflight region at the time of a crash.

3. The method of claim 2, further comprising performing a sanity check on a block of the inflight region.

4. The method of claim 1, wherein the physical storage is cloud-based.

5. A computer program product for recovering a log-structured file system, comprising a non-transitory computer readable medium having program instructions embodied therein for:
defining a recovery region of the log-structured file system;
selecting a set of metadata blocks for the recovery region;
selecting a first set of logical blocks referred to by the set of metadata blocks;
accepting the logical blocks in the first set of logical blocks into the log-structured file system;
selecting the second set of logical blocks for the recovery region such that each of the logical blocks in the second set is in an intermediate state;
accepting into the log-structured file system logical blocks in the second set that pass a validation test; and
synchronizing logical storage and physical storage of the log-structured file system.

6. The computer program product of claim 6, further comprising determining an inflight region at the time of a crash.

7. The computer program product of claim 7, further comprising performing a sanity check on a block of the inflight region.

8. The computer program product of claim 6, wherein the physical storage is cloud-based.

9. A system for recovering a log-structured file system comprising a non-transitory computer readable medium and a processor configured to execute instructions comprising:
sending a request to a cloud store for backup data;
receiving from the cloud store a set of backup data comprising a set of data and metadata objects;
reading the set of metadata objects in a logical order; and
writing each metadata object from the set of data and metadata objects into block storage of the log-structured file system.

10. The system of claim 9, further comprising determining an inflight region at the time of a crash.

11. The system of claim 10, further comprising performing a sanity check on a block of the inflight region.

12. The system of claim 9, wherein the physical storage is cloud-based.
